(19) United States
(12) Patent Application Publication
(10) Pub. No.: US 2021/0181001 A1
(43) Pub. Date: Jun. 17, 2021

(54) UNMANNED AERIAL VEHICLE POSITIONING SYSTEM, HANDHELD RTK POSITIONING DEVICE, AND SEALED QUICK RELEASE STRUCTURE

(71) Applicant: SZ DJI TECHNOLOGY CO., LTD., Shenzhen (CN)

(72) Inventors: Chi ZHANG, Shenzhen (CN); Jiangang FENG, Shenzhen (CN)

(21) Appl. No.: 17/186,672

(22) Filed: Feb. 26, 2021

Related U.S. Application Data
(63) Continuation of application No. PCT/CN2018/102543, filed on Aug. 27, 2018.

(51) Int. Cl. G01D 11/24; G01D 11/30; B64C 39/02

(52) U.S. Cl. CPC G01D 11/245; G01D 11/30; B64C 2201/12; B64C 2201/146; B64C 39/024

(57) ABSTRACT

A sealed quick release structure includes a main enclosure provided with an accommodation member and a mounting surface, the mounting surface including an opening in communication with the accommodation member; a sealing cover accommodated in an accommodation groove and slidable in the accommodation groove to cover and seal the opening; and a fixing cover detachably disposed at the mounting surface and including the accommodation groove, the fixing cover being configured to slide relative to the mounting surface and the sealing cover between a lock position, at which the fixing cover is connected with the main enclosure and is pressed against the sealing cover; and an unlock position, at which the fixing cover is separated from the main enclosure to allow the sealing cover to be separated from the opening.

### CROSS-REFERENCE TO RELATED APPLICATION

This application is a continuation of International Application No. PCT/CN2018/102543, filed on Aug. 27, 2018, the entire content of which is incorporated herein by reference.

### TECHNICAL FIELD

The present disclosure relates to the technical field of an enclosure disassembly structure and, more particularly, to an unmanned aerial vehicle (UAV) positioning system, a handheld RTK positioning device, and a sealed quick release structure.

### BACKGROUND

Currently, making a sealed connection through an enclosure opening includes two aspects: quick disassembly and reassembly of the enclosure and secure seal of the enclosure. Trade-offs often need to be made between these two aspects. To realize the quick disassembly and reassembly of the enclosure may sacrifice the secure seal of the enclosure while to realize the secure seal of the enclosure may sacrifice the quick disassembly and reassembly of the enclosure. It is difficult to achieve both the quick disassembly and reassembly of the enclosure and the secure seal of the enclosure at the same time. However, as technologies advance, both quick disassembly and reassembly and the secure seal of the enclosure become highly desired requirement in more and more product designs and play an important role. Thus, more and more products require realization of both quick disassembly and reassembly and the secure seal. Product designs of the existing enclosures are often unable to satisfy this requirement and it is difficult to achieve both the quick disassembly and reassembly and the secure seal of a same enclosure product.

### SUMMARY

In accordance with the disclosure, there is provided a sealed quick release structure. The sealed quick release structure includes a main enclosure provided with an accommodation member and a mounting surface, the mounting surface including an opening in communication with the accommodation member; a sealing cover accommodated in an accommodation groove and slidable in the accommodation groove to cover and seal the opening; and a fixing cover detachably disposed at the mounting surface and including the accommodation groove, the fixing cover being configured to slide relative to the mounting surface and the sealing cover between a lock position, at which the fixing cover is connected with the main enclosure and is pressed against the sealing cover; and an unlock position, at which the fixing cover is separated from the main enclosure to allow the sealing cover to be separated from the opening.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a perspective view of a fixed RTK positioning device according to an example embodiment of the present disclosure.

FIG. 2 is a perspective view of a handheld RTK positioning device according to an example embodiment of the present disclosure.

FIG. 3 is an exploded view of a sealed quick release structure according to an example embodiment of the present disclosure.

FIG. 4 is an exploded view of the sealed quick release structure in FIG. 3 from another angle.

FIG. 5 is a schematic structural diagram of the sealed quick release structure in

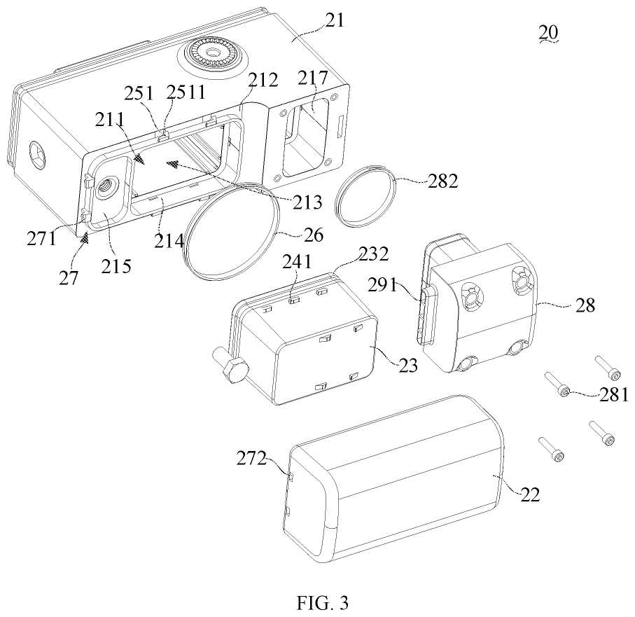

FIG. 3.

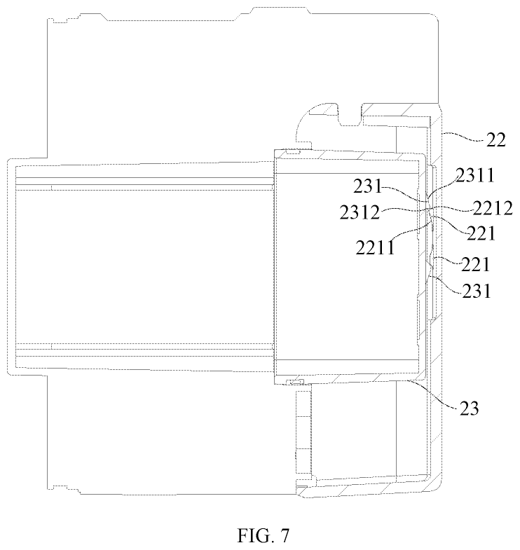

FIG. 6 is a cross-sectional view of the sealed quick release structure in FIG. 5 along an F-F cross-sectional line.

FIG. 7 is a cross-sectional view of the sealed quick release structure in FIG. 5 along an E-E cross-sectional line.

### REFERENCE NUMERALS

10: fixed RTK positioning device
11: tripod
20: sealed quick release structure
21: main enclosure
211: accommodation member
212: mounting surface
213: opening
214: first limit groove
215: second limit groove
216: limit step
217: communication cavity
22: fixing cover
220: receiving groove
221: first limit protrusion
2211: first inclined surface
222: reinforcement rib
23: sealing cover
231: second limit protrusion
2311: second inclined surface
232: step portion
24: sliding structure
241: sliding protrusion
242: guiding groove
243: protruding extension
25: snapping structure
251: positioning hook
2511: limit member
252: positioning sliding groove
2521: sliding member
2522: snapping member
2523: opening portion
26: sealing member
27: locking structure
271: locking hook
272: locking hole
28: secondary fixing cover
281: bolt
282: sealing ring
29: foolproof structure
291: coupling member
30: handheld RTK positioning device

### DETAILED DESCRIPTION OF THE EMBODIMENTS

Embodiments of the present disclosure are described in detail below with reference to the accompanying drawings. It will be appreciated that the described embodiments are some rather than all of the embodiments of the present disclosure. Other embodiments obtained by those having ordinary skills in the art on the basis of the described embodiments without inventive efforts should fall within the scope of the present disclosure.

As such, a feature indicated in this specification is used to describe one of the features of the embodiments of the present disclosure, rather than implying that the embodiments of the present disclosure must have the described feature. In addition, this specification describes many features. Although certain features are combined to illustrate possible system designs, these features can also be combined in manners that are not explicitly indicated. Thus, unless otherwise specified, the illustrated combinations are not intended to be limiting.

In the embodiments shown in the drawings, direction indications (such as up, down, left, right, front, and back) are used to explain structures and movements of various elements of the present disclosure, which are not absolute but relative. When the elements are in positions shown in the drawings, the descriptions are appropriate. If description of the positions of the elements changes, the direction indications will also change accordingly.

Hereinafter, some embodiments of the present disclosure will be further described in detail with reference to the accompanying drawings in the specification. In case of no conflict, the embodiments and features described in the embodiments can be combined with each other.

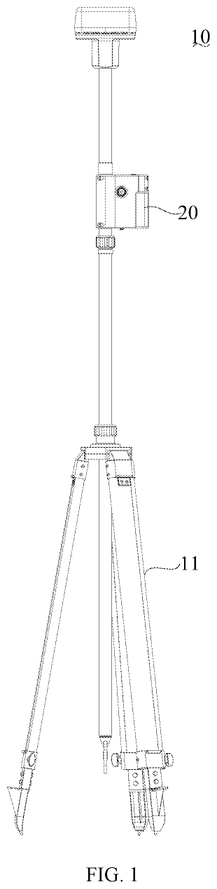

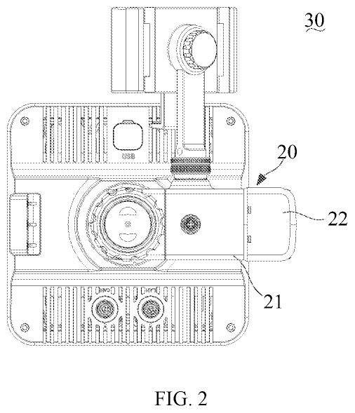

The present disclosure provides an unmanned aerial vehicle (UAV) positioning system. Referring to FIG. 1 and FIG. 2, the UAV positioning system includes a fixed real-time kinematic (RTK) positioning device 10 and a handheld RTK positioning device 30. The fixed RTK positioning device 10 is communicatively connected to the handheld RTK positioning device 30. The fixed RTK positioning device 10 is provided with a tripod 11. The tripod 11 is used to support and fix the fixed RTK positioning device 30.

In some embodiments, the handheld RTK positioning device 30 includes a battery module (not shown) and a sealed quick release structure 20. The battery module is sealed and waterproofly accommodated in the sealed quick release structure 20. The sealed quick release structure 20 prevents the battery module from being exposed to water and ensures normal operation of the battery module.

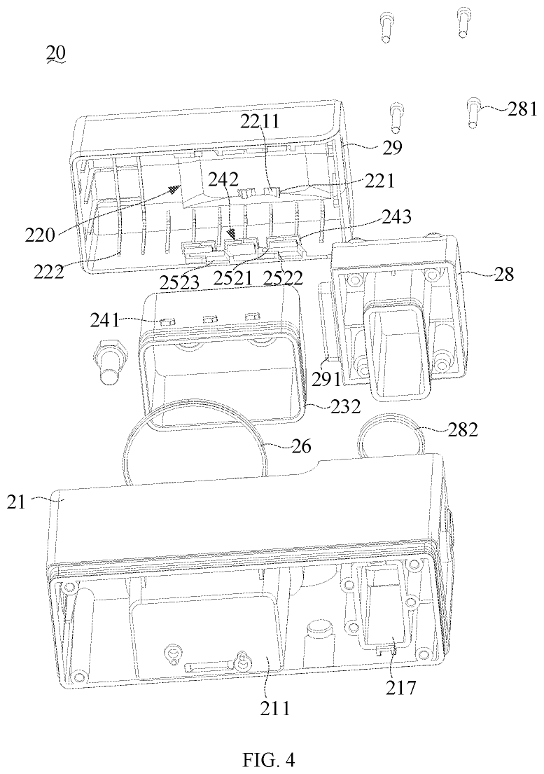

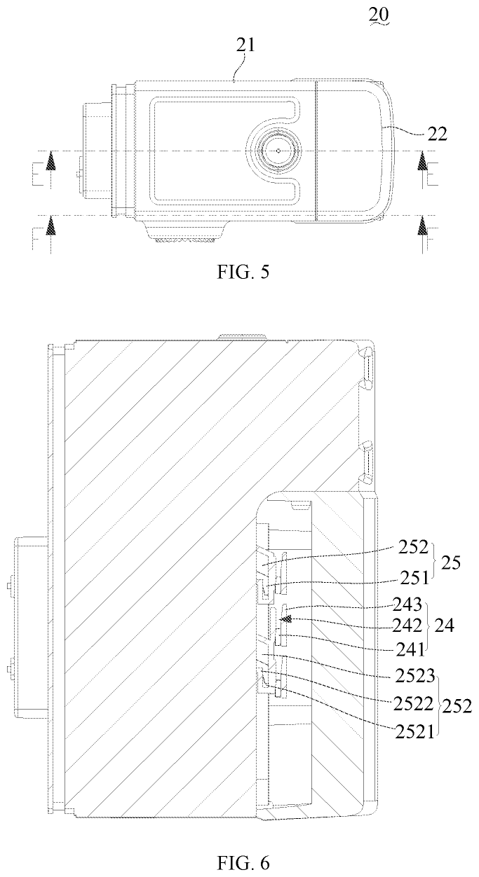

Referring to FIG. 3 and FIG. 4, in some embodiments, the sealed quick release structure 20 includes a main enclosure 21, a fixing cover 22, and a sealing cover 23.

The main enclosure 21 is a primary part of the sealed quick release structure 20. The main enclosure 21 is a cuboid structure. The main enclosure 21 is provided with an accommodation member 211 and a mounting surface 212. The accommodation member 211 is a cavity structure for accommodating electronic components of the handheld positioning device 30. The mounting surface 212 is located at a side surface of the main enclosure 21. The main enclosure 21 includes an opening 213 at the mounting surface 212. The opening 213 is in communication with the accommodation member 211.

In some embodiments, the accommodation member 211 is a battery compartment. The battery module is accommodated inside the battery compartment. The battery module is placed into the battery compartment through the opening 213. Specifically, the battery compartment is a cuboid cavity adapted to a shape and size of the battery module. The sealing cover 23 and the fixing cover 22 seal the battery compartment.

The fixing cover 22 is detachably provided at the mounting surface 212. The fixing cover 22 is able to slide relative to the mounting surface 212 and includes a lock position and a unlock position. The fixing cover 22 is provided with a receiving groove 220. The receiving groove 220 is a rectangular groove. The fixing cover 22 is fixed to the mounting surface 212, and is disposed opposite to the accommodation member 211 and the opening 213.

The sealing cover 23 is received inside the receiving groove 220. The sealing cover 23 is nested in the fixing cover 22 and forms a combined cover structure with the fixing cover 22. The sealing cover 23 covers the opening 213 for sealing the opening 213. Moreover, the sealing cover 23 is able to slide in the receiving groove 220. The sealing cover 23 is able to slide in the fixing cover 22, such that the fixing cover 22 is able to slide relative to the sealing cover 23 between the lock position and the unlock position.

In the sealed quick release structure 20, the fixing cover 22 and the sealing cover 23 are nested together to form the combined cover structure. Through slidably snapping the sealing cover 23 at the fixing cover 22, the fixing cover 22 is detachably mounted at the main enclosure 21. Detachably mounting the fixing cover 22 can realize mounting of the sealing cover 23. The combined cover structure is easy to assemble and quick to disassemble. When the fixing cover 22 slides to the unlock position, the fixing cover 22 is separated from the main enclosure 21, such that the sealing cover 23 is separated from the opening 213.

Moreover, the fixing cover 22 preliminarily seals the opening 213 of the man enclosure 21, and the sealing cover 23 is fixed at the opening 213 to form a double seal, thereby improving the dealing performance of the overall combined cover structure. When the fixing cover 22 slides to the lock position, the fixing cover 22 connects to fix to the main enclosure 21 and presses against the sealing cover 23. The fixing cover 22 presses against the sealing cover 23 at the opening 213 to further enhance the sealing and waterproof performance.

Referring to FIG. 5 and FIG. 6, in some embodiments, the sealing cover 23 and the fixing cover 22 are slidably connected by a sliding structure 24. The sliding structure 24 is provided between an outer side wall of the sealing cover 23 and an inner side wall of the fixing cover 22. Because the sealing cover 23 and the fixing cover 22 are nested, the side walls of the sealing cover 23 and the fixing cover 22 are arranged opposite to each other. The sliding structure can be conveniently provided between the side walls of the sealing cover 23 and the fixing cover 22. In some embodiments, the sliding structure 24 may be disposed at the side wall of the receiving groove 220 relative to the bottom of the receiving groove 220, which is not limited by the present disclosure.

In some embodiments, the sliding structure 24 is disposed adjacent to the sealing cover 23 and the opening 213 of the fixing cover 22. The sliding structure 24 includes a siding protrusion 241 and a guiding groove 242. The sliding protrusion 241 is accommodated in the guiding groove 242 and slides along the guiding groove 242. The sliding protrusion 241 is disposed at the outer side wall of the sealing cover 23. The guiding groove 242 is disposed at the inner side wall of the fixing cover 22.

The guiding groove 242 is longer than a distance between the lock position and the unlock position. That is, it is ensured that when the sliding protrusion 241 slides along the guiding groove 242, the sealing cover 23 can be smoothly positioned.

In some embodiments, one or more sliding structures 24 are provided. The one or more sliding structures 24 are disposed at opposite sides of the sealing cover 23 and the fixing cover 22.

In some embodiments, the sliding structure 24 further includes a plurality of protruding extensions 243 arranged at intervals. Each protruding extension 243 is provided with the guiding groove 242. The sliding protrusion 241 is slidably pushed against the protruding extension 243. The guiding groove 242 is formed on the surface of the protruding extension 243. Moreover, the guiding groove 242 of each of the plurality of protruding extensions 243 is located on a same straight line and the guiding grooves 242 of the plurality of protruding extensions 243 are connected to form one guiding groove 242. The sliding protrusion 241 slides along the protruding extensions 243.

The sliding protrusion 241 is shorter than the interval between two adjacent protruding extensions 243, such that the sliding protrusion 241 can slide into the guiding groove 242 through the gap between two adjacent protruding extensions 243. When the sliding protrusion 241 meets the gap between two adjacent protruding extensions 243, the sliding protrusion 241 slides into the guiding groove 242 through the gap, contacts the surface of the protruding extension 243, and slides on the surface of the protruding extension 243.

A first limit protrusion 221 is disposed at the bottom of the inner side wall of the receiving groove 220 of the fixing cover 22. A second limit protrusion 231 is disposed at the top of the outer side wall of the sealing cover 23. When the sealing cover 23 slides to the lock position, the first limit protrusion 221 and the second limit protrusion 231 press against each other so that the fixing cover 22 presses against the sealing cover 23.

When the sealing cover 23 slides relative to the fixing cover 22, the first limit protrusion 221 and the second limit protrusion 231 get close to each other and press against each other. The first limit protrusion 221 and the second limit protrusion 231 increase the distance between the fixing cover 22 and the sealing cover 23, thereby pressing the sealing cover 23 toward the main enclosure 21.

The distance between the first limit protrusion 221 and the second limit protrusion 231 is equal to the distance between the unlock position and the lock position. The distance between the first limit protrusion 221 and the second limit protrusion 231 is the distance the sealing cover 23 slides relative to the fixing cover 22. When the sealing cover 23 slides, the distance the sealing cover 23 slides is equal to the distance between the first limit protrusion 221 and the second limit protrusion 231. As such, when the sealing cover 23 presses against the fixing cover 22 through the first limit protrusion 221 and the second limit protrusion 231, the sealing cover 23 slides into a desired position, that is, the fixing cover 22 reaches the unlock position or the lock position.

Referring to FIG. 7, the first limit protrusion 221 is provided with a first inclined surface 2211 and the second limit protrusion 231 is provided with a second inclined surface 2311. The first inclined surface 2211 is adapted to the second inclined surface 2311. When the first inclined surface 2211 is pressed against the second inclined surface 2311, the first inclined surface 2211 and the second inclined surface 2311 coordinate to facilitate the first limit protrusion 221 and the second limit protrusion 231 to contact with each other and continue to slide, such that the first limit protrusion 221 and the second limit protrusion 231 are pressed against and overlapped with each other.

In some embodiments, one or more first limit protrusions 221 and second limit protrusions 231 are provided. The one or more first limit protrusions 221 and the one or more second limit protrusions 231 coordinate to ensure that the sealing cover 23 and the fixing cover 22 are stably pressed against each other so that forces between the sealing cover 23 and the fixing cover 22 are uniform.

In some embodiments, four first limit protrusions 221 are provided in two groups. Each group includes two. Four second limit protrusions 231 are provided in two groups. Each group includes two. Two first limit protrusions 221 in a same group are arranged opposite to each other along a sliding direction of the fixing cover 22.

When the sealing cover 23 slides from the unlock position to the lock position, the first limit protrusion 221 located at the front of the sealing cover 23 in the sliding direction has a cross-sectional area resembling a right-angled triangle and is hence called a right-angled first limit protrusion 221. Correspondingly, the second limit protrusion 231 corresponding to the right-angled first limit protrusion 221 also has a cross-sectional area resembling a right-angled triangle and is hence called a right-angled second limit protrusion 231. The right-angled first limit protrusion 221 is provided with a first inclined surface and the right-angled second limit protrusion 231 is provided with a second inclined surface. The first inclined surface and the second inclined surface are pressed against each other to assist the right-angled second limit protrusion 231 to slide relative to the right-angled first limit protrusion 221 from the unlock position to the lock position.

After the sealing cover 23 slides from the unlock position to the lock position, a right-angled side of the right-angled first limit protrusion 221 and a right-angled side of the right-angled second limit protrusion 231 are pressed against and snapped with each other, thereby preventing the right-angled second limit protrusion 231 from sliding away from the right-angled first limit protrusion 221.

The first limit protrusion 221 located at the rear in the sliding direction of the sealing cover 23 is pressed against another second limit protrusion 231 to spread pressure between the fixing cover 22 and the sealing cover 23, such that the forces between the fixing cover 22 and the sealing cover 23 are uniform.

In addition, when the sealing cover 23 slides to the lock position, the two first limit protrusions 221 are clamped between the two second limit protrusions 231, such that the first limit protrusions 221 and the second limit protrusions 231 are stably pressed against each other.

The first inclined surfaces 2211 of the two first limit protrusions 221 have opposite inclination angles. An angle between the first inclined surface 2211 and an inner bottom surface of the receiving groove 220 of the fixing cover 22 is an acute angle and an angle between the first inclined surfaces 2211 of the two first limit protrusions 221 in a same group is an obtuse angle. Correspondingly, the second inclined surfaces 2311 of the two second limit protrusions 231 have opposite inclination angles. An angle between the second inclined surface 2311 and an outer top surface of the sealing cover 23 is an acute angle and an angle between the second inclined surfaces 2311 of the two second limit protrusions 231 in a same group is an obtuse angle. When a group of the first limit protrusions 221 and a group of second limit protrusions 231 are pressed against each other, the first inclined surface 2211 and the second inclined surfaces 2311 are stably pressed against each other. The inclination angle between the first inclined surface 2211 and the second inclined surface 2311 facilitates the second limit protrusion 231 to slide away between the two first limit protrusions 221.

Reinforcement ribs 222 are provided at the inner side of the fixing cover 22. The reinforcement ribs 222 ensure the strength of the fixing cover 22 to prevent damages caused by excessive forces. One or more reinforcement ribs 22 are provided and arranged in parallel. Heights of the reinforcement ribs 222 match the shape of the sealing cover 23 and vary with the shape of the sealing cover 23, such that the reinforcement ribs 222 provided in the fixing cover 22 do not occupy the internal space of the receiving groove 220 of the fixing cover 22 to interfere with the mounting of the sealing cover 23.

The fixing cover 22 and the main enclosure 21 are snap-connected by a snapping structure 25. The snapping structure 25 includes a positioning hook 251 and a positioning sliding groove 252. The positioning hook 251 slides along the positioning sliding groove to snap, such that the fixing cover 22 and the main enclosure 21 are snap-connected. The positioning sliding groove 252 matches the shape of the positioning hook 251.

Referring to FIG. 6, the positioning sliding groove 252 includes a sliding member 2521 and snapping member 2522. The snapping member 2522 is disposed at one end of the sliding member 2521. The sliding member 2521 and the snapping member 2522 form an L-shape. Correspondingly, the positioning hook 251 is also in an L-shape. The sliding member 2521 is in a slim shape. The positioning sliding groove 252 is provided with an opening portion 2523 at the snapping member 2522. The positioning hook 251 enters the positioning sliding groove 252 through the opening portion 2523, such that the positioning hook 251 slides along the sliding member 2521. The positioning hook 251 is provided with a limit member 2511 being pressed against the snapping member 2522. The limit member 2511 and the snapping member 2522 are pressed against each other when the sealing cover 23 slides to the lock position. When the snapping member 2522 and the limit member 2511 are pressed against each other, the limit member 2511 is accommodated in the opening portion 2523 and is pressed against the snapping member 2522. Thus, the positioning hook 251 and the positioning sliding groove 252 are snapped and fixed.

The sliding member 2521 is longer than the distance between the lock position and the unlock position. When the positioning hook 251 slides along the sliding member 2521 of the positioning sliding groove 252, the fixing cover 22 is able to move between the lock position and the unlock position.

The fixing cover 22 slides relative to the mounting surface 212 in a direction substantially parallel with a direction that the fixing cover 22 slides relative to the sealing cover 23, thereby facilitating the operation and the mounting of the fixing cover 22.

In some embodiments, the positioning hook 251 is disposed at a periphery of the opening 213 of the main enclosure 21. The positioning sliding groove 252 is disposed at the opening end of the fixing cover 22. The positioning sliding groove 252 and the snapping hook 251 are arranged opposite to each other.

In some embodiments, the positioning hook 251 is disposed at the opening end of the fixing cover 22 and the positioning sliding groove 252 is disposed at the periphery of the opening 213 of the main enclosure 21.

In some other embodiments, the positioning sliding groove 252 is disposed at the inner side of the fixing cover 22 and the positioning hook 251 is disposed at the outer side of the main enclosure 21, as long as the positioning sliding groove 252 and the positioning hook 251 are snap-connected. Thus, the fixing cover 22 and the main enclosure 21 are detachably connected.

When the fixing cover 22 slides to the lock position, the positioning hook 251 of the main enclosure 21 and the positioning sliding groove 252 of the fixing cover 22 are snap-connected, and the fixing cover 22 is connected relative to the main enclosure 21 and is pressed against the sealing cover 23. The fixing cover 22 is tightly pressed against the sealing cover 23, such that the sealing covers 23 seals the opening 213, thereby ensuring the sealing performance of the accommodation member 211.

When the fixing cover 22 slides to the unlock position, the positioning hook 251 of the main enclosure 21 and the positioning sliding groove 252 of the fixing cover 22 are separated, and the fixing cover 22 is separated relatively from the main enclosure 21, such that the sealing cover 23 is separated from the opening 213. Thus, the fixing cover 22 and the sealing cover 23 are relatively detached from the main enclosure 21, thereby facilitating the disassembly.

A first limit groove 214 is provided at the main enclosure 21. The first limit groove 214 is disposed at the outer side of the opening 213 of the main enclosure 21. The opening end of the fixing cover 22 is accommodated in the first limit groove 214. The first limit groove 214 facilitates the alignment and snap-connection between the fixing cover 22 and the main enclosure 21.

A second limit groove 215 is provided at the main enclosure 21. The second limit groove 215 is disposed in the first limit groove 214 and is arranged opposite to the sealing cover 23. The opening end of the sealing cover 23 is accommodated in the second limit groove 215. The second limit groove 215 facilitates the alignment between the sealing cover 23 and the opening 213 of the main enclosure 21. In addition, a step portion 232 is provided at the outer side wall of the opening end of the sealing cover 23. The step portion 232 is pressed against the inner side wall of the second limit groove 215.

A limit step 216 is provided at the inner side wall at the bottom of the second limit groove 215. The step portion 232 of the sealing cover 23 and the limit step 216 are pressed against each other.

A sealing member 26 is provided between the sealing cover 23 and the opening 213 of the main enclosure 21. The sealing member 26 is disposed surrounding the opening 213 of the main enclosure 21. The sealing member 26 is pressed between the sealing cover 23 and the main enclosure 21.

Specifically, the sealing member 26 is disposed surrounding the step portion 231 if the sealing cover 23. The step portion 231 of the sealing cover 23 is pressed against the limit step 216. The sealing member 26 is pressed exactly between the outer side wall of the sealing cover 23 and the inner side wall of the first limit groove 214. The sealing member 26 is tightly pressed to ensure that the sealing member 26 is able to seal the opening 213.

In some embodiments, the sealing member 26 may be a sealing ring or a sealing gasket. The sealing member 26 may also be a plastic ring or a rubber ring.

The sealed quick release structure further includes a lock structure 27. The lock structure 27 lock-connects the fixing cover 22 with the main enclosure 21. The lock structure 27 includes a locking hook 271 and locking hole 272. The locking hook 271 is accommodated in the locking hole 272 to lock the fixing cover 22 with the main enclosure 21. The locking structure 27 further fixes and snaps the fixing cover 22 with the main enclosure 21 to ensure that the fixing cover 22 and the main enclosure 21 are stably connected.

In some embodiments, the lock structure 27 is disposed at a position where the fixing cover 22 and the main enclosure 21 are connected.

One or more lock structures 27 may be provided. The one or more lock structures 27 reinforce the connection between the fixing cover 22 and the main enclosure 21. In some embodiments, two lock structures 27 are provided.

The handheld RTK positioning device 30 further includes a communication module. The sealed quick release structure 20 further includes a secondary fixing cover 28. The main enclosure 21 is provided with a communication cavity 217. The communication module is accommodated in the communication cavity 217. The secondary fixing cover 28 seals the communication cavity 217. The fixing cover 22 seals the battery compartment.

The secondary fixing cover 28 is disposed at a side of the fixing cover 22 and is detachably connected to the main enclosure 21. In some embodiments, the secondary fixing cover 28 is provided with a plurality of screw holes. Correspondingly, the main enclosure 21 is provided with a plurality of screw holes. The secondary fixing cover 28 is fastened to the main enclosure 21 by bolts 281. In some other embodiments, the secondary fixing cover 28 and the main enclosure 21 may be detachably connected by a snap connection method such as a snap or a hook.

One side of the fixing cover 22 is provided with a foolproof structure 29. The main enclosure 21 is provided with a coupling member 291 coupling with the foolproof structure 29. The foolproof structure 29 includes a foolproof protrusion or a foolproof hole. In some embodiments, the fixing cover 22 is provided with the foolproof hole. The secondary fixing cover 28 is provided with the coupling member 291. The coupling member 291 is the foolproof protrusion coupling with the foolproof hole. In some other embodiments, the secondary fixing cover 28 may be omitted. When the secondary fixing cover 28 is omitted, the coupling member may be disposed directly at the main enclosure 21.

Specifically, the fixing cover 22 is provided with the foolproof hole at the side wall facing toward the secondary fixing cover 28 and the secondary fixing cover 28 is provided with the foolproof protrusion at the side wall facing toward the fixing cover 22. The foolproof protrusion and the foolproof hole are arranged opposite to each other, such that the foolproof protrusion is accommodated in the foolproof hole. In some other embodiments, the foolproof protrusion and the foolproof hole switch places, which is not limited by the present disclosure as long as the foolproof protrusion and the foolproof hole are coupled with each other.

When the fixing cover 22 slides relative to the dealing cover 23 to the lock position, the fixing cover 22 is prevented by the foolproof structure 29 and the coupling member 291 from covering the opening 213. Thus, the foolproof structure 29 prevents the fixing cover 22 and the sealing cover 23 from being assembled when the fixing cover 22 is located at the lock position.

When the fixing cover 22 slides relative to the sealing cover 23 to the unlock position, the fixing cover 22 is able to cover the opening 213. When the fixing cover 22 slides to the lock position, the foolproof structure 29 exactly couples with the coupling member 291. Only when the fixing cover 22 is located at the unlock position, the fixing cover 22 can be slid to the lock position, such that the fixing cover 22 tightly presses against the sealing cover 23 and the sealing cover 23 tightly presses the opening 213 of the main enclosure 21.

The foolproof protrusion and the foolproof hole are sealed and connected, which prevents the foolproof structure 29 and the foolproof hole from degrading the sealing performance of the sealed quick release structure while ensuring the overall waterproof performance of the sealed quick release structure.

A sealing ring 282 is provided between the secondary fixing cover 28 and the main enclosure 21. The sealing ring 282 keeps the secondary fixing cover 28 and the main enclosure 21 in a sealed connection, ensuring that the communication module in the communication cavity 217 is sealed and waterproof.

Referring again to FIG. 1, the fixed RTK positioning device 10 also includes the sealed quick release structure 20. Similarly, the sealed quick release structure 20 may also ensure the sealing performance of electrical modules such as the battery module and the communication module of the fixed RTK positioning device, ensure the waterproof safety, and achieve the airtightness up to IPX7 level.

In addition, the sealed quick release structure 20 can be quickly disassembled, which convenient for installation and maintenance. As such, the entire UAV positioning system can also be installed quickly and detachably while ensuring the sealing and waterproof performance, thereby reducing manual maintenance cost.

In the specification, specific examples are used to explain the principles and implementations of the present disclosure. The description of the embodiments is intended to assist comprehension of the methods and core inventive ideas of the present disclosure. At the same time, those of ordinary skill in the art may change or modify the specific implementation and the scope of the application according to the embodiments of the present disclosure. Thus, the content of the specification should not be construed as limiting the present disclosure.

What is claimed is:

1. A sealed quick release structure comprising:
a main enclosure provided with an accommodation member and a mounting surface, the mounting surface including an opening in communication with the accommodation member;
a sealing cover accommodated in an accommodation groove and slidable in the accommodation groove to cover and seal the opening; and
a fixing cover detachably disposed at the mounting surface and including the accommodation groove, the fixing cover being configured to slide relative to the mounting surface and the sealing cover between:
a lock position, at which the fixing cover is connected with the main enclosure and is pressed against the sealing cover; and
an unlock position, at which the fixing cover is separated from the main enclosure to allow the sealing cover to be separated from the opening.

2. The sealed quick release structure according to claim 1, wherein:
the sealing cover and the fixing cover are connected by a sliding structure including a sliding protrusion and a guiding groove; and
the sliding protrusion is accommodated in the guiding groove and slidable along the guiding groove.

3. The sealed quick release structure according to claim 2, wherein:
the sliding structure is disposed between an outer side wall of the sealing cover and an inner side wall of the fixing cover.

4. The sealed quick release structure according to claim 2, wherein:
the sliding structure is one of a plurality sliding structures of the sealed quick release structure, the plurality of sliding structures being arranged at two opposite sides of the sealing cover and the fixing cover.

5. The sealed quick release structure according to claim 2, wherein:
the sliding protrusion is disposed at an outer side wall of the sealing cover; and
the guiding groove is disposed at an inner side wall of the fixing cover.

6. The sealed quick release structure according to claim 2, wherein:
the guiding groove is longer than or equal to a distance between the lock position and the unlock position.

7. The sealed quick release structure according to claim 2, wherein:
the guiding groove is one of a plurality of guiding grooves of the sliding structure;
the sliding structure further includes a plurality of protruding extensions arranged at intervals, each of the protruding extensions being provided with one of the guiding grooves; and
the sliding protrusion is shorter than a distance between two adjacent protruding extensions of the plurality of protruding extensions, and is configured to slide into the guiding groove of one of the two adjacent protruding extensions through a gap between the two adjacent protruding extensions.

8. The sealed quick release structure according to claim 1, wherein:
a first limit protrusion is disposed at a bottom of an inner side wall of the accommodation groove of the fixing cover;
a second limit protrusion is disposed at a top of an outer side wall of the sealing cover; and
when the sealing cover slides to the lock position, the first limit protrusion and the second limit protrusion are pressed against each other, such that the fixing cover presses against the sealing cover.

9. The sealed quick release structure according to claim 8, wherein:
a distance between the first limit protrusion and the second limit protrusion is equal to a distance between the unlock position and the lock position.

10. The sealed quick release structure according to claim 8, wherein:
the first limit protrusion is provided with a first inclined surface; and
the second limit protrusion is provided with a second inclined surface configured to be coupled with the first inclined surface.

11. The sealed quick release structure according to claim 8, wherein:
the first limit protrusion is one of a plurality of first limit protrusions of the fixing cover; and
the second limit protrusions is one of a plurality of second limit protrusions of the sealing cover.

12. The sealed quick release structure according to claim 1, wherein:
the fixing cover and the main enclosure are snap-connected by a snapping structure including a positioning hook and a positioning sliding groove; and
the positioning hook is configured to slide along the positioning sliding groove to snap, to snap connect the fixing cover and the main enclosure.

13. The sealed quick release structure according to claim 12, wherein:
the positioning sliding groove includes a sliding member and a snapping member;
the snapping member is disposed at one end of the sliding member; and
the positioning sliding groove matches a shape of the positioning hook.

14. The sealed quick release structure according to claim 13, wherein:
the sliding member is longer than or equal to a distance between the lock position and the unlock position.

15. The sealed quick release structure according to claim 13, wherein:
a limit member is provided at the positioning hook and is configured to be pressed against the snapping member; and
the limit member and the snapping member are pressed against each other when the sealing cover slides to the lock position.

16. The sealed quick release structure according to claim 12, wherein:
the positioning hook is disposed at a periphery of the opening of the main enclosure;
the positioning sliding groove is disposed at an opening end of the fixing cover; and
the positioning sliding groove and the snapping hook are arranged opposite to each other.

17. The sealed quick release structure according to claim 12, wherein:
the positioning sliding groove is disposed at an inner side of the fixing cover and the positioning hook is disposed at an outer side of the sealing cover.

18. The sealed quick release structure according to claim 1, wherein:
a limit groove is provided at the main enclosure and disposed at an outer side of the opening of the main enclosure; and
an opening end of the fixing cover is accommodated in the limit groove.

19. The sealed quick release structure according to claim 18, wherein:
the limit groove is a first limit groove;
a second limit groove is provided at the main enclosure, the second limit groove being disposed in the first limit groove and arranged opposite to the sealing cover; and
an opening end of the sealing cover is accommodated in the second limit groove.
